(19) United States
(12) Patent Application Publication
(10) Pub. No.: US 2010/0152893 A1
(43) Pub. Date: Jun. 17, 2010

(54) Method and apparatus for on-demand kiosk fulfillment with origination, billing, and management via telecommunications network

(76) Inventors: Christopher Percing Fure, Berkeley, CA (US); Frank Ting Kong Cheung, San Francisco, CA (US)

Correspondence Address: Chris Fure, 2510 Russell Street, Berkeley, CA, 94705, US

(21) Appl. No.: 12/316,192

(22) Filed: Dec. 11, 2008

(51) Int. Cl. G06F 17/00; G06Q 30/00; G07F 7/00; H04M 15/00; H04W 4/12; G06F 17/30

(52) U.S. Cl. 700/237; 705/34; 700/238; 379/114.25; 455/466; 707/E17.001

(57) ABSTRACT

An automated method of purchasing kiosk items, where a toll call from a variety of typically mobile appliances (i.e. cell phone, PDA, tablet PC, personal desktop or laptop computer, etc.) activates an apparatus that causes the automated kiosk to fulfill demanded items upon successful validation and billing via an interface to a telecommunications network. A mobile phone can therefore be billed by dialing a “1-900” type toll number and specify the desired product via touch tone commands, or by similarly “texting” the order to a designated telecommunications recipient. Furthermore, the apparatus includes a means to provide maintenance and diagnostics and services so as to minimize operating costs of the kiosk system, along with necessary management services such as inventory control. The kiosk can be interfaced with the telecommunications network in a variety of ways, such as, but not limited to POTS modem for twisted pair copper, DSL modem for twisted pair copper, Ethernet controller for CAT-5, etc., and includes a plurality of sensors and actuators to execute the variety of functionalities specified (i.e., motors to deploy product, temperature sensor to qualify product, image capture device to validate delivery of product, etc.). The apparatus may include a central server to interact with the end user and to deliver network commands (e.g., present end-user with options, accept order from end-user, identify inventory, deploy particular product, query current kiosk status, etc.), as well as report product description and billing data back to the mobile appliance's telecommunication network.

### FIELD OF INVENTION

The present invention relates to electronic devices, and means for data communication using electronic devices. More particularly, the invention relates to a solution for an automated kiosk receiving data from an electronic device using a toll call for data billing and vended item fulfillment.

### BACKGROUND

The invention seeks to provide products or services via automated kiosks while dispensing with the need to have cash in hand as would be the case of a traditional vending machine. The fulfillment takes place over existing telecommunications infrastructure so as to have a minimum implementation barrier. At the present moment, 1-900 style telephone based billing services are a mature and established technology available and ideal for coupling with an automated kiosk product fulfillment, along with some newer technologies such as internet based payment options.

### DRAWING

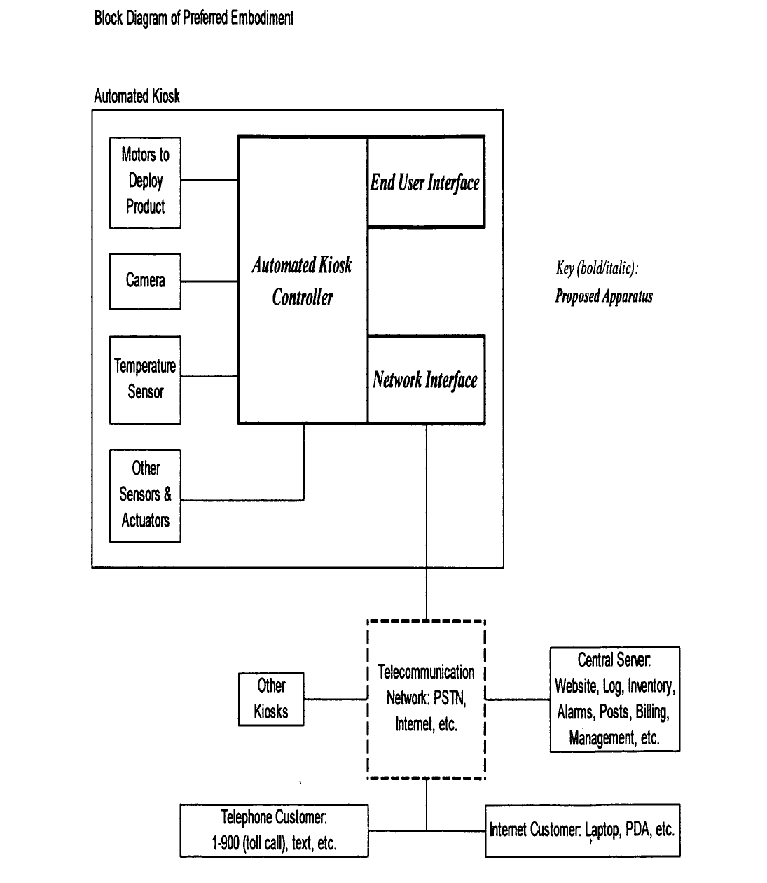

In FIG. 1, a system block diagram illustrates a possible system-level implementation of the claims stated herein. A telephone customer, such as a mobile phone user, may dial a designated “1-900” toll call which is routed to a central server. The order may also be placed from an internet computer and settled via submission of a credit card or other internet payment system. The central server prompts the end-user and accepts the end-user's order and bills the end-user accordingly. Subsequently, it communicates a command to deploy the desired product to the automated kiosk controller via the telecommunications network (“telcom”) and the kiosks's interface. The release of the product might require the end user to identify himself by a proper PIN code at the end-user interface physically present at the automated kiosk; the PIN code might have been pre-determined and given to end user at time of billing, or it might have been chosen by end-user at time of billing. No cash need be present at the actual automated kiosk site. The automated kiosk deploys product by turning on the requisite motors or actuators, and may validate delivery by capturing an image or a video of the end-user taking delivery of product to the central server. The automated kiosk may also measure characteristics of the product (such as coffee temperature) for quality assurance purposes, and transmit such data back to the central server. Furthermore, the displayed pricing of the products might be updated on demand by instructions originating from the central server to the various deployed automated kiosks. Furthermore, the central server may also update or upgrade automated kiosk software by sending such updates via the telecommunications network.

An alternative embodiment may be a simplified stand-alone version of the preferred embodiment, where the central server is perhaps physically located within the automated kiosk itself.

1. A method of using a telecommunications network to remotely order a product on demand, coupled with the fulfillment of product delivery by an automated kiosk operating within the framework of a validation, billing, and/or inventory management system.

2. The method according to claim 1, in which the order and billing can be accomplished through a “1-900” or similar style toll call.

3. The method according to claim 1, in which the apparatus can be networked to a digital server to feed data about the automated kiosk, such as inventory availability, product deployment, operational status of the kiosk, etc.
The method according to claim 1, in which the order and billing can be accomplished through a “text page” via a mobile phone.

4. The method according to claim 1, in which the apparatus comprises of an interface for the automated kiosk to communicate via physical medium, including, but limited to POTS modem for twisted pair copper, DSL modem for twisted pair copper, Ethernet controller for CAT-5, GPRS/EDGE/1xRTT for wireless data, etc. The interfaces may be cascaded in implementation and are not restricted to implementation at exactly one physical installation site. (An automated kiosk may be interfaced to a GPRS network which then is interfaced to a standard telcom network at the mobile carrier to land line site.)

5. The method according to claim 1, in which a management system can supply necessary information for billing data as required for accounts receivables purposes.
The method according to claim 2, in which an interactive voice/touch-tone system provides an end-user interface to accept order and respond to user as appropriate and necessary.
The method according to claim 3, in which an interactive “mobile texting” system provides an end-user interface to accept text orders and to respond to user as appropriate and necessary.
The method according to claim 1, in which the apparatus can validate the identity of the proper recipient by verifying against a pre-determined Personal Identifier Number (PIN) or other unique identifying characteristic (Smart Card, Employee Card, etc.)

6. The method according to claim 1, in which the apparatus can validate the delivery of the product by capturing an image or a video of the end-user picking up or taking possession of the ordered product.

7. The method according to claim 1, in which the apparatus can validate the quality of the product by logging and reporting the measured product characteristics at the time of the delivery, such as the temperature of a beverage at the time of fulfillment.

8. A method in which the automated kiosk functionality can be upgraded or updated on demand via its telecommunications interface.
A method for managing and updating the pricing of various products at various kiosks on demand via its telecommunications interface.

9. The method according to claim 1, in which the order can be accomplished through a computer access to a designated internet website.
The method according to claim 13, in which a payment can be accomplished via credit card submission or other types of internet payment submission (Paypal, etc.)
The present invention may be embodied in other alternate forms without departing from the spirit or essential characteristics thereof. Not all embodiments require implementation of each and every claim. Therefore, the presently discussed embodiments are considered to be illustrative and not restrictive, the scope of the invention being indicated by the appended claims rather than the invention description, and all changes which come within the meaning and range of equivalency of the claims are therefore intended to be embraced therein. [Claim #2 can't be circumvented by inventing a new “1-922” or “1-700” or “1-600” number. Claim #4 can't be circumvented by using 802.11g instead of wired Ethernet.]
